(19) United States
(12) Patent Application Publication
(10) Pub. No.: US 2026/0135575 A1
(43) Pub. Date: May 14, 2026

(54) MULTI-PATH POWER EFFICIENT PASSIVE SPLIT WITH ENHANCED LINEARITY

(71) Applicant: QUALCOMM Incorporated, San Diego, CA (US)

(72) Inventors: Prakash THOPPAY EGAMBARAM, San Diego, CA (US); Jang Joon LEE, San Diego, CA (US); Kyle David HOLLAND, San Diego, CA (US); Aleksandar Miodrag TASIC, San Diego, CA (US); Bo WEN, San Diego, CA (US)

(21) Appl. No.: 18/943,134

(22) Filed: Nov. 11, 2024

(51) Int. Cl. H04B 1/00; H04B 1/04

(52) U.S. Cl. CPC H04B 1/0096; H04B 1/0483

(57) ABSTRACT

A radio frequency (RF) signal receiver, including: a set of downconverters; a set of passive signal routing paths extending from a first signal splitting node to the set of downconverters via a first set of switching devices, respectively; and a set of active signal routing paths extending from the first signal splitting node or a second signal splitting node to the set of downconverters via a set of amplifiers, respectively.

### FIELD

This disclosure relates generally to radio frequency (RF) signal receiver, and in particular, to an RF signal receiver including a signal splitting node and a set of passive signal routing paths extending from the signal splitting node to a set of downconverters, the set of passive signal routing paths configured to route an RF signal to the set of downconverters while bypassing a set of active signal routing paths extending to the set of downconverters, respectively.

### BACKGROUND

Some radio frequency (RF) signal receivers are configured to process received RF signals each including a set of carriers in accordance with a carrier aggregation (CA) receive mode. In such RF signal receivers, a set of frequency downconverters are configured to frequency downconvert the RF signal frequency bands associated with the set of carriers to a set of baseband (BB) signals, respectively. It is of interest to route the received RF signals to the set of frequency downconverters in a power efficient and undistorted manner.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a radio frequency (RF) signal receiver. The RF signal receiver includes: a set of downconverters; a set of passive signal routing paths extending from a first signal splitting node to the set of downconverters via a first set of switching devices, respectively; and a set of active signal routing paths extending from the first signal splitting node or a second signal splitting node to the set of downconverters via a set of amplifiers, respectively.

Another aspect of the disclosure relates to a method of receiving and processing radio frequency (RF) signals. The method includes: splitting an RF signal into a set of RF signal portions; and routing at least one of the set of RF signal portions to at least one of a set of downconverters via at least one of a set of passive signal routing paths extending from a first signal splitting node to the at least one of the set of downconverters, while bypassing at least one of a set of active signal routing paths extending from the first signal splitting node or a second signal splitting node to the at least one of the set of downconverters, respectively.

Another aspect of the disclosure relates to an apparatus. The apparatus includes: means for splitting an RF signal into a set of RF signal portions; and means for routing at least one of the set of RF signal portions to at least one of a set of downconverters via at least one of a set of passive signal routing paths extending from a first signal splitting node to the at least one of the set of downconverters, while bypassing at least one of a set of active signal routing paths extending from the first signal splitting node or a second signal splitting node to the at least one of the set of downconverters, respectively.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1A illustrates a block diagram of an example radio frequency (RF) signal receiver in a two-carrier non-contiguous carrier aggregation (NCCA) receive mode in accordance with an aspect of the disclosure.

FIG. 1B illustrates a block diagram of the example radio frequency (RF) signal receiver of FIG. 1A in a two-carrier contiguous carrier aggregation (CCA) receive mode in accordance with another aspect of the disclosure.

FIG. 1C illustrates a frequency spectrum graph of an example two-carrier NCCA RF signal in accordance with another aspect of the disclosure.

FIG. 1D illustrates a frequency spectrum graph of an example two-carrier CCA RF signal in accordance with another aspect of the disclosure.

FIG. 1E illustrates a flow diagram of an example method of receiving and processing a two-carrier NCCA RF signal in accordance with another aspect of the disclosure.

FIG. 1F illustrates a flow diagram of an example method of receiving and processing a two-carrier CCA RF signal in accordance with another aspect of the disclosure.

FIG. 2A illustrates a block diagram of the example RF signal receiver of FIG. 1A in a three-carrier NCCA or CCA receive mode in accordance with another aspect of the disclosure.

FIG. 2B illustrates a frequency spectrum graph of an example three-carrier NCCA RF signal in accordance with another aspect of the disclosure.

FIG. 2C illustrates a frequency spectrum graph of an example three-carrier CCA RF signal in accordance with another aspect of the disclosure.

FIG. 2D illustrates a flow diagram of an example method of receiving and processing a three-carrier NCCA or CCA RF signal in accordance with another aspect of the disclosure.

FIG. 3A-1 illustrates a block diagram of another example RF signal receiver in a two-carrier NCCA or CCA receive mode in accordance with another aspect of the disclosure.

FIG. 3A-2 illustrates a flow diagram of another example method of receiving and processing two-carrier NCCA or CCA RF signal in accordance with another aspect of the disclosure.

FIG. 3B-1 illustrates a block diagram of the RF signal receiver of FIG. 3A-1 in a three-carrier NCCA or CCA receive mode in accordance with another aspect of the disclosure.

FIG. 3B-2 illustrates a flow diagram of another example method of receiving and processing a NCCA or CCA RF signal in accordance with another aspect of the disclosure.

FIG. 3C-1 illustrates a block diagram of the RF signal receiver of FIG. 3A-1 in a hybrid active-passive three-carrier NCCA RF signal receive mode in accordance with another aspect of the disclosure.

FIG. 3C-2 illustrates a flow diagram of another example method of receiving and processing a three-carrier NCCA RF signal in accordance with another aspect of the disclosure.

FIG. 4A illustrates a block diagram of an example radio frequency (RF) signal receiver in a four-carrier NCCA or CCA RF signal receive mode in accordance with another aspect of the disclosure.

FIG. 4B illustrates a flow diagram of an example method of receiving and processing a four-carrier NCCA or CCA RF signal in accordance with another aspect of the disclosure.

FIG. 5 illustrates a block diagram of an example wireless communication system in accordance with another aspect of the disclosure.

FIG. 6 illustrates a block diagram of an example transceiver in accordance with another aspect of the disclosure.

FIG. 7 illustrates a block diagram of an example RF signal receiver in accordance with another aspect of the disclosure.

FIG. 8 illustrates a flow diagram of an example method of receiving and processing RF signals in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. The term “substantially” means that the associated parameter may not be exact as indicated but accounts for some variation due to specified tolerances.

Wireless communication devices (e.g., wireless devices for short), such as user equipment (UE) communicating with a wireless wide area network (WWAN) (e.g., fifth or sixth generation (5G) or (6G) New Radio (NR)) and/or other type(s) of network, often have different bandwidth demands depending on how they are used. For example, video conferencing, gaming, and streaming typically require high bandwidth demands, while internet surfing, texting, and emailing typically require low bandwidth demands.

In high bandwidth demands, a practical bandwidth, from a user experience perspective, for one or more applications running on a wireless device may exceed the bandwidth of a single download link between a base station and the wireless device. In such case, a set of download links (signal-modulated carriers) may be set up between a base station and a wireless device, such that the cumulative bandwidth of the set of download links is used to send data from the base station to the wireless device at the required data rate. This is referred to as carrier aggregation (CA).

Sometimes the frequency bands associated with the set of signal-modulated carriers occupy a contiguous frequency range. This scenario may be referred to as contiguous carrier aggregation (CCA). Other times the frequency bands associated with the set of signal-modulated carriers occupy disjointed or non-overlapping frequency ranges. This scenario may be referred to as non-contiguous carrier aggregation (NCCA). Under the category of NCCA, there may be multiple intra-CA and inter-carrier aggregation scenarios, where the non-contiguous frequency band signals may have been transmitted by different base stations.

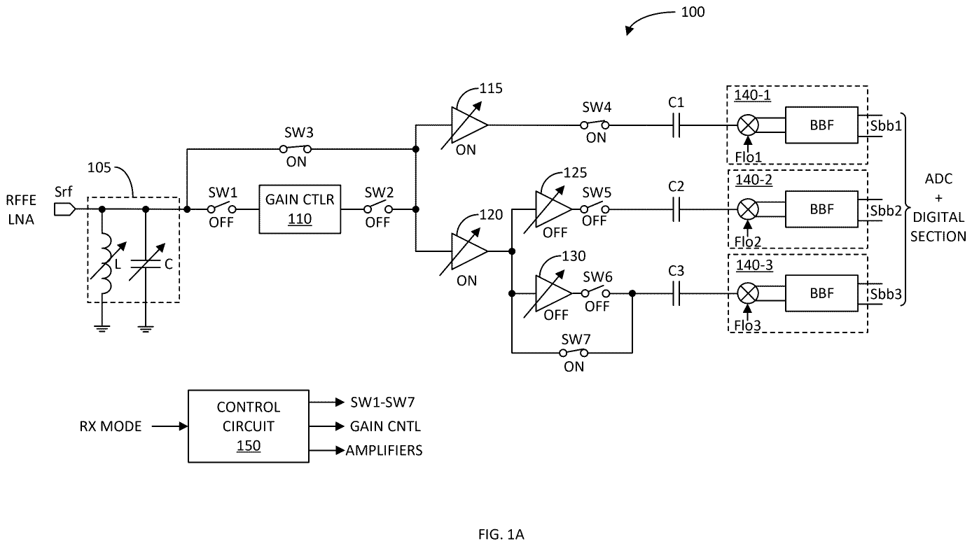

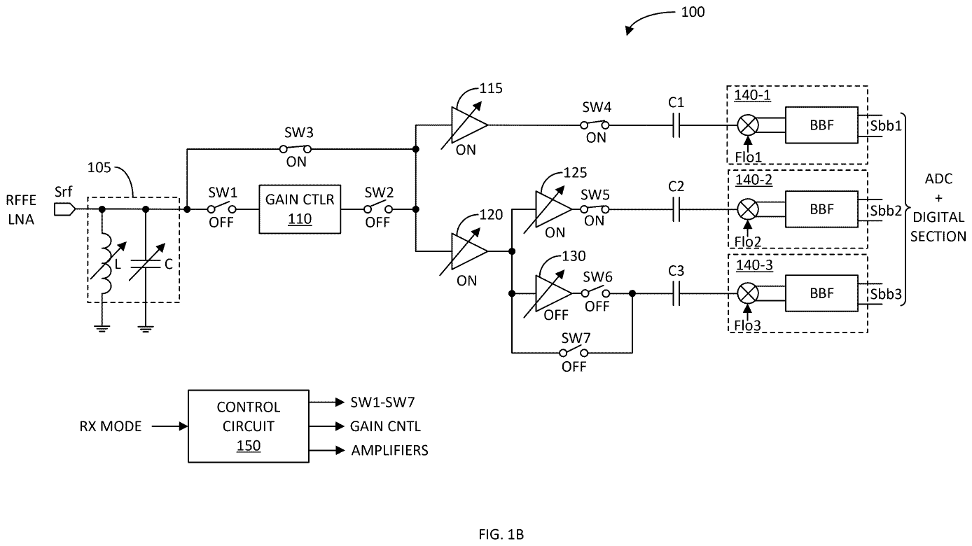

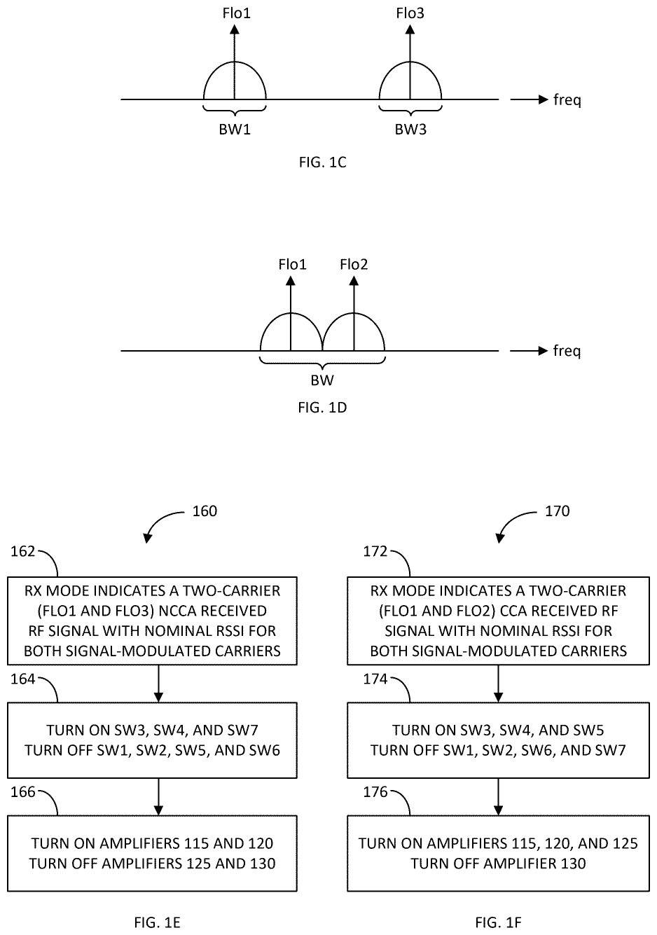

FIG. 1A illustrates a block diagram of an example radio frequency (RF) signal receiver 100 in accordance with an aspect of the disclosure. The receiver 100 may be situated between one or more RF front-end (RFFE) low noise amplifiers (LNAs) and an analog-to-digital converter (ADC) followed by a digital section or more generally between an antenna and a baseband processor. The receiver 100 includes an impedance matching circuit 105 (e.g., parallel shunt inductor L and capacitor C, one or both of which may be programmable or variable), an optional gain control circuit 110 (e.g., a programmable signal attenuator), a set of switching devices SW1 to SW7 (e.g., field effect transistors (FETs), transmission gates, pass gates, etc.), a set of amplifiers (e.g., low noise amplifiers (LNAs)) 115, 120, 125, and 130 (e.g., where one or more may be turned ON/OFF, and may have a programmable gain), a set of alternating current (AC)-coupled capacitors C1 to C3, a set of downconverters 140-1 to 140-3 (e.g., each including a mixer and a baseband filter (BBF)), and a control circuit 150.

The set of amplifiers 115-130 and the set of switching devices SW1-SW7 may be part of an active signal routing network configured to route a received RF signal Srf including one or more signal-modulated carriers from an RF signal input (e.g., coupled to an output of one or more RFFE LNAs) to the set of downconverters 140-1 to 140-3 via a set of active signal routing paths (e.g., a path including one or more active circuits (e.g., a circuit required to be powered by a supply voltage and/or current), such as the amplifiers 115-130 in this example).

The active signal routing network may include two active signal routing paths to route a received RF signal Srf from the RF signal input to the first downconverter 140-1. For example, the received RF signal Srf may be routed to the first downconverter 140-1 via a first active path including switching device SW3, amplifier 115, switching device SW4, and AC-coupled capacitor C1. The received RF signal Srf may also be routed to the first downconverter 140-1 via a second active path including switching device SW1, gain control circuit 110, switching device SW2, amplifier 115, switching device SW4, and AC-coupled capacitor C1.

Similarly, the active signal routing network may include two active signal routing paths to route a received RF signal Srf from the RF signal input to the second downconverter 140-2. For example, the received RF signal Srf may be routed to the second downconverter 140-2 via a third active path including switching device SW3, amplifier 120, amplifier 125, switching device SW5, and AC-coupled capacitor C2. The received RF signal Srf may also be routed to the second downconverter 140-2 via a fourth active path including switching device SW1, gain control circuit 110, switching device SW2, amplifier 120, amplifier 125, switching device SW5, and AC-coupled capacitor C2.

In a like manner, the active signal routing network may include four active signal routing paths to route a received RF signal Srf from the RF signal input to the third downconverter 140-3. For example, the received RF signal Srf may be routed to the third downconverter 140-3 via a fifth active path including switching device SW3, amplifier 120, amplifier 130, switching device SW6, and AC-coupled capacitor C3. The received RF signal Srf may also be routed to the third downconverter 140-3 via a sixth active path including switching device SW1, gain control circuit 110, switching device SW2, amplifier 120, amplifier 130, switching device SW6, and AC-coupled capacitor C3. The received RF signal Srf may also be routed to the third downconverter 140-3 via a seventh active path including switching device SW3, amplifier 120, switching device SW7, and AC-coupled capacitor C3. The received RF signal Srf may also be routed to the third downconverter 140-3 via an eighth active path including switching device SW1, gain control circuit 110, switching device SW2, amplifier 120, switching device SW7, and AC-coupled capacitor C3.

FIG. 1C illustrates a frequency spectrum graph of an example two-carrier non-contiguous carrier aggregation (NCCA) RF signal in accordance with another aspect of the disclosure. The horizontal axis represents frequency. The vertical axis represents signal power. As shown, in a two-carrier NCCA case, the received RF signal includes a first signal-modulated carrier Flo1 situated within a first frequency band with a bandwidth BW1 and a second signal-modulated carrier Flo2 situated within a second frequency band with a bandwidth BW3. The first and second frequency bands are disjoined in frequency or have non-overlapping bandwidths BW1 and BW3, respectively.

FIG. 1D illustrates a frequency spectrum graph of an example two-carrier contiguous carrier aggregation (CCA) RF signal in accordance with another aspect of the disclosure. The horizontal axis represents frequency. The vertical axis represents signal power. As shown, in a two-carrier CCA case, the received RF signal includes a first signal-modulated carrier Flo1 situated within a first frequency band and a second signal-modulated carrier Flo2 situated within a second frequency band. The first and second frequency bands are contiguous in frequency with a cumulative bandwidth BW.

FIG. 1E illustrates a flow diagram of an example method 160 of receiving and processing a two-carrier (Flo1 and Flo3) NCCA RF signal Srf in accordance with another aspect of the disclosure. With additional reference to FIG. 1A, the method 160 includes the control circuit 150 receiving a receive (RX) mode signal indicating a two-carrier (Flo1 and Flo3) NCCA received RF signal Srf with nominal power level for both signal-modulated carriers (e.g., the received signal strength indicator (RSSI) of each of the corresponding baseband (BB) signals Sbb1 and Sbb3 being below a threshold (TH)) (block 162). In response to the receive mode, the control circuit 150 enables the first and seventh active signal routing paths of the active signal routing network.

In this regard, the control circuit 150 turns ON switching devices SW3, SW4, and SW7, and turns OFF switching devices SW1, SW2, SW5, and SW6 (block 164). Additionally, the control circuit 150 turns ON amplifiers 115 and 120, and turns OFF amplifiers 125 and 130 (block 166). Thus, the received RF signal Srf is routed to the first downconverter 140-1 via switching device SW3, amplifier 115, switching device SW4, and AC-coupled capacitor C1. The first downconverter 140-1 is configured to frequency downconvert the signal-modulated carrier Flo1 to baseband signal Sbb1. The received RF signal Srf is also routed to the third downconverter 140-3 via switching device SW3, amplifier 120, switching device SW7, and AC-coupled capacitor C3. The third downconverter 140-3 is configured to frequency downconvert the signal-modulated carrier Flo3 to baseband signal Sbb3.

FIG. 1F illustrates a flow diagram of an example method 170 of receiving and processing a two-carrier (Flo1 and Flo2) CCA RF signal in accordance with another aspect of the disclosure. With additional reference to FIG. 1B, the method 170 includes the control circuit 150 receiving a receive mode signal indicating a two-carrier (Flo1 and Flo2) CCA received RF signal with nominal power level for both signal-modulated carriers Flo1 and Flo2 (e.g., RSSI of each Sbb1 and Sbb2 being<TH) (block 172). In response to the receive mode, the control circuit 150 enables the first and third active signal routing paths of the active signal routing network.

In this regard, the control circuit 150 turns ON switching devices SW3, SW4, and SW5, and turns OFF switching devices SW1, SW2, SW6, and SW7 (block 174). Additionally, the control circuit 150 turns ON amplifiers 115, 120, and 125, and turns OFF amplifier 130 (block 176). Thus, the received RF signal Srf is routed to the first downconverter 140-1 via switching device SW3, amplifier 115, switching device SW4, and AC-coupled capacitor C1. The first downconverter 140-1 is configured to frequency downconvert the signal-modulated carrier Flo1 to baseband signal Sbb1. The received RF signal Srf is also routed to the second downconverter 140-2 via switching device SW3, amplifier 120, amplifier 125, switching device SW5, and AC-coupled capacitor C2. The second downconverter 140-2 is configured to frequency downconvert the signal-modulated carrier Flo2 to baseband signal Sbb2.

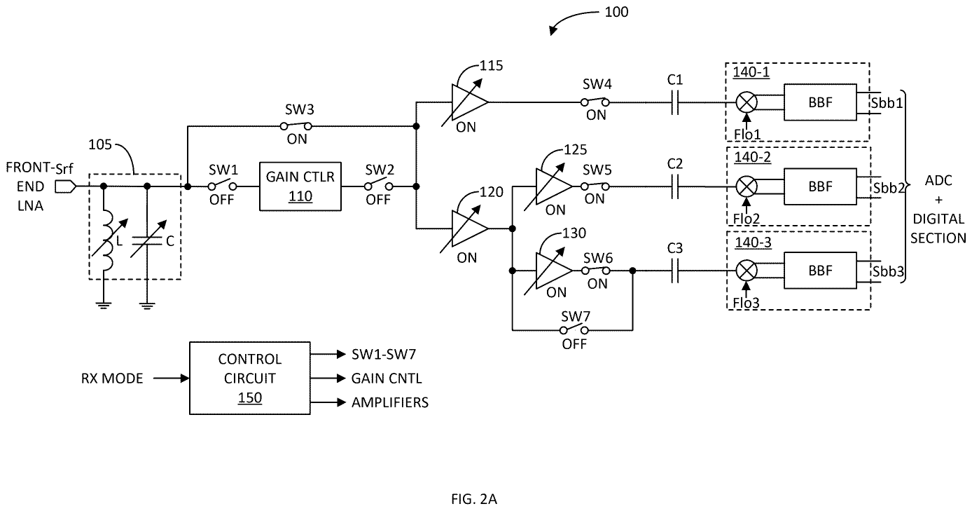

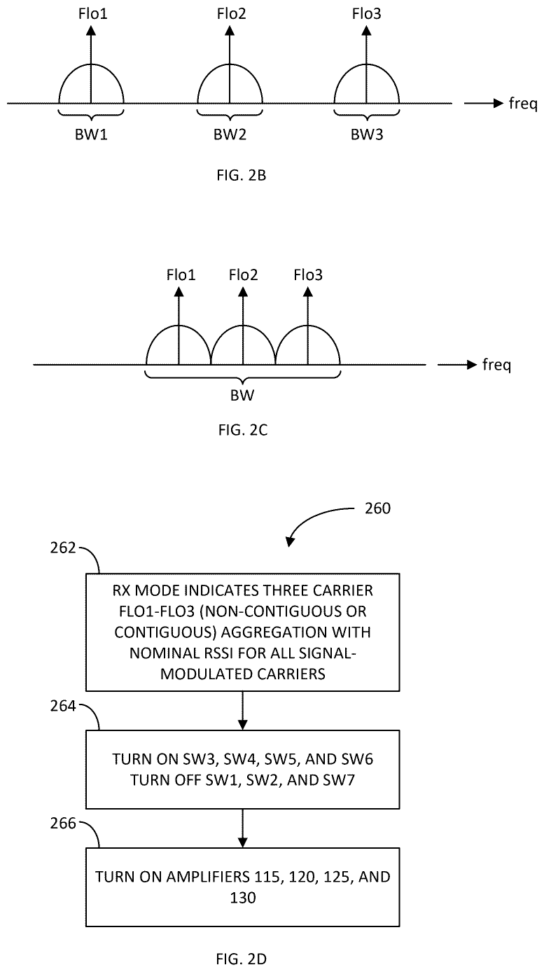

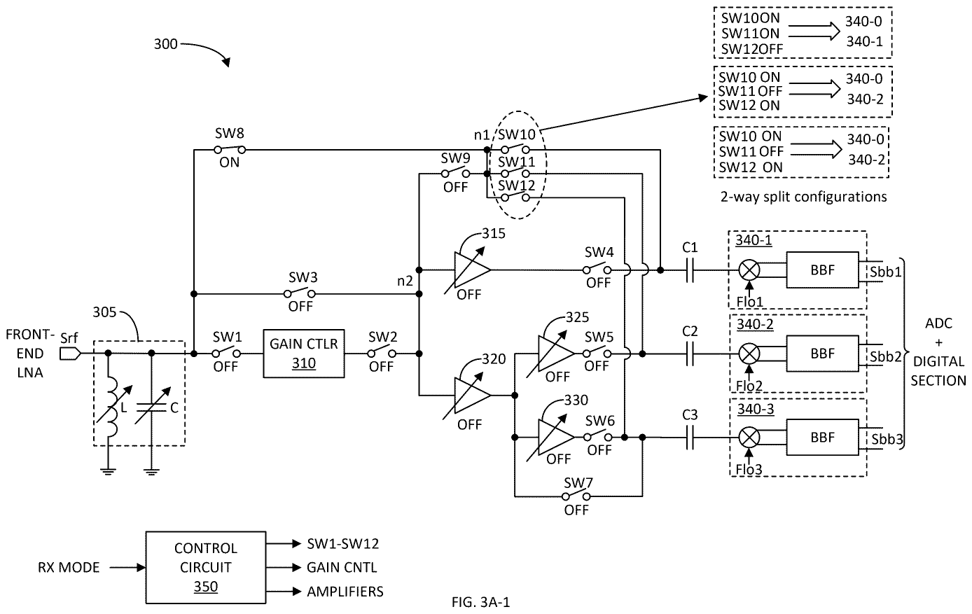

FIG. 2B illustrates a frequency spectrum graph of an example non-contiguous three (3) carrier aggregation (CA) received RF signal in accordance with another aspect of the disclosure. The horizontal axis represents frequency. The vertical axis represents signal power. As shown, in a non-contiguous CA case, the received RF signal includes a first signal-modulated carrier Flo1 situated within a first frequency band with a first bandwidth BW1, a second signal-modulated carrier Flo2 situated within a second frequency band with a second bandwidth BW2, and a third signal-modulated carrier Flo3 situated within a third frequency band with a third bandwidth (BW3). The first, second, and third frequency bands are disjoined in frequency or have non-overlapping bandwidths BW1, BW2, and BW3, respectively.

FIG. 2C illustrates a frequency spectrum graph of an example contiguous three (3) carrier aggregation (CA) received RF signal in accordance with another aspect of the disclosure. The horizontal axis represents frequency. The vertical axis represents signal power. As shown, in a contiguous CA case, the received RF signal includes a first signal-modulated carrier Flo1 situated within a first frequency band, a second carrier frequency Flo2 situated within a second frequency band, and a third signal-modulated carrier Flo3 situated within a third frequency band. The first, second, and third frequency bands are contiguous in frequency with a cumulative bandwidth BW.

FIG. 2D illustrates a flow diagram of an example method 260 of receiving a three-carrier (Flo1-Flo3) NCCA or CCA RF signal in accordance with another aspect of the disclosure. With additional reference to FIG. 2A, the method 260 includes the control circuit 150 receiving a receive mode signal indicating a three-carrier (Flo1-Flo3) NCCA or CCA RF signal Srf with nominal power level (e.g., RSSI of each Sbb1, Sbb2, and Sbb3 being <TH)) for all signal-modulated carriers (block 262). In response to the receive mode, the control circuit 150 enables the first, third, and fifth active signal routing paths of the active signal routing network.

In this regard, the control circuit 150 turns ON switching devices SW3, SW4, SW5, and SW6, and turns OFF switching devices SW1, SW2, and SW7 (block 264). Additionally, the control circuit 150 turns ON amplifiers 115, 120, 125, and 130 (block 266). Thus, the received RF signal Srf is routed to the first downconverter 140-1 via switching device SW3, amplifier 115, switching device SW4, and AC-coupled capacitor C1. The first downconverter 140-1 is configured to frequency downconvert the signal-modulated carrier Flo1 to baseband signal Sbb1. The received RF signal Srf is routed to the second downconverter 140-2 via switching device SW3, amplifier 120, amplifier 125, switching device SW5, and AC-coupled capacitor C2. The second downconverter 140-2 is configured to frequency downconvert the signal-modulated carrier Flo2 to baseband signal Sbb2. The received RF signal Srf is routed to the third downconverter 140-3 via switching device SW3, amplifier 120, amplifier 130, switching device SW6, and AC-coupled capacitor C3. The third downconverter 140-3 is configured to frequency downconvert the signal-modulated carrier Flo3 to baseband signal Sbb3.

As all of the paths are active in this implementation, the received RF signal Srf encounters one or more active devices, such as amplifiers, which consume power. In some cases, the power level of the received RF signal Srf is sufficiently high that no amplification of the received RF signal is required, resulting in a waste of power. Furthermore, in some cases, the power level of received RF signal Srf is significantly high that it may adversely impact the linearity of the amplifiers, resulting in distortion in the received signal.

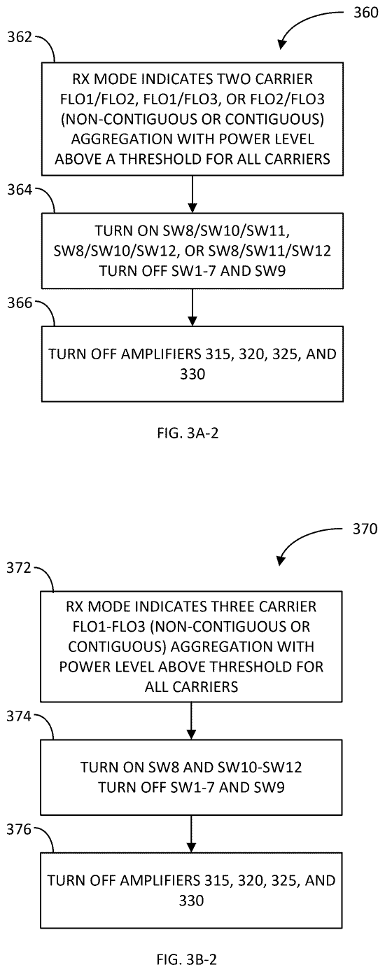

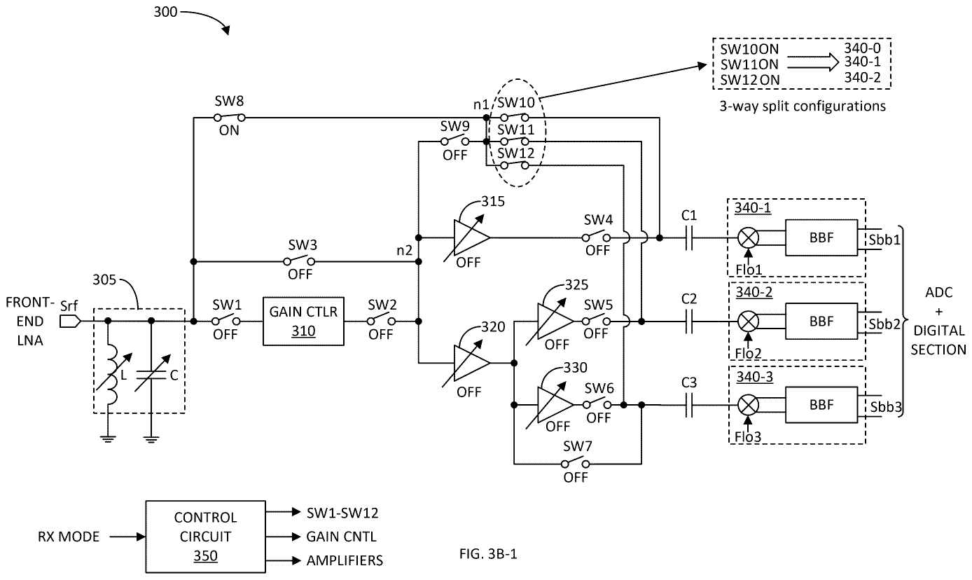

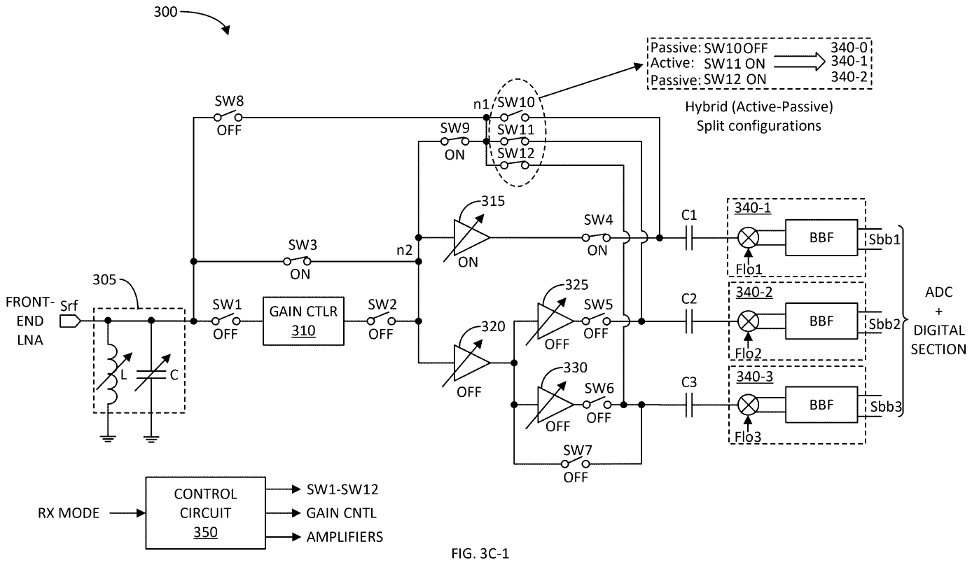

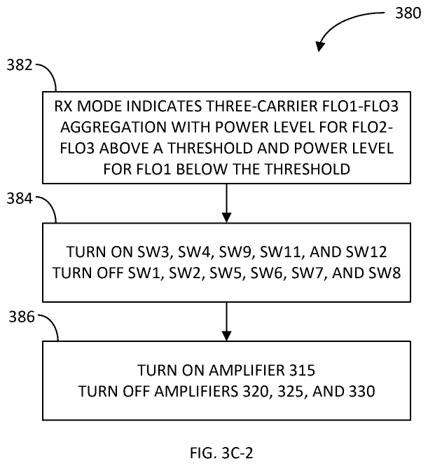

FIG. 3A-1 illustrates a block diagram of an example RF signal receiver 300 configured to receive and process non-contiguous carrier aggregation (NCCA) and contiguous carrier aggregation (CCA) RF signals in accordance with another aspect of the disclosure. In addition to the active signal routing network discussed with reference to RF signal receiver 100, the receiver 300 includes a passive signal routing network that employs a signal split, passive signal routing paths, and bypassing active signal routing paths architecture for selectively routing a received RF signal from an RF signal input to two or more downconverters. A passive path is one that does not employ any RF signal amplification stage, and is there to bypass one or more active paths including amplifiers (e.g., LNAs) between an RF signal input and a downconverter.

In particular, the receiver 300 includes an active signal routing network including a set of active signal routing paths. That is, the receiver 300 includes a set of switching devices SW4-SW7 (e.g., FETs, transmission gates, pass gates, etc.) and a set of amplifiers (e.g., LNAs) 315, 320, 325, and 330. In this example, the active signal routing network includes the following four (4) active signal routing paths extending from a second signal splitting node n2 to a set of downconverters 340-1 to 340-3:
(1) node n2→amplifier 315→SW4→C1→downconverter 340-1
(2) node n2→amplifier 320→amplifier 325→SW5→C2→downconverter 340-2
(3) node n2→amplifier 320→amplifier 330→SW6→C3→downconverter 340-3
(4) node n2→amplifier 320→SW7→C3→downconverter 340-3

The receiver 300 further includes a passive signal routing network including a set of passive signal routing paths extending from a first signal splitting node n1 and the set of downconverters 340-1 to 340-3, respectively. The set of passive signal routing paths include a set of switching devices SW10 to SW12 (e.g., FETs, transmission gates, pass gates, etc.), respectively. More specifically, the passive signal routing paths may include the following:
(1) node n1→SW10→C1→downconverter 340-1
(2) node n1→SW11→C2→downconverter 340-2
(3) node n1→SW12→C3→downconverter 340-3

Additionally, the receiver 300 includes a set of signal routing paths extending from an RF signal input (e.g., to which an output of an RFFE LNA may be coupled) and the first and second signal splitting nodes n1 and n2, respectively. In this regard, the receiver 300 includes an impedance matching circuit 305 (e.g., parallel shunt inductor L and capacitor C, one or both of which may be programmable or variable), switching devices SW1-SW3, and SW8, and a gain control circuit 310. A first signal routing path extending from the RF signal input to the first signal splitting node n1 includes the impedance matching circuit 305 and switching device SW8. A second signal routing path extending from the RF signal input to the second signal splitting node n2 includes the impedance matching circuit 305 and switching device SW3. A third signal routing path extending from the RF signal input to the second signal splitting node n2 includes the impedance matching circuit 305, switching device SW1, gain control circuit 310, and switching device SW2.
Additionally, the receiver 300 includes a fourth signal routing path extending from the second signal splitting node n2 to the first signal splitting node n1 including switching device SW9. The control circuit 350 is configured to receive a receive (RX) mode signal, and control the switching devices SW1-SW12 (e.g., ON/OFF states), gain control circuit 310 (e.g., signal attenuation), and amplifiers 315, 320, 325, and 330 (e.g., ON/OFF states and gains).
FIG. 3A-2 illustrates a flow diagram of an example method 360 of receiving and processing a two-carrier (Flo1/Flo2, Flo1/Flo3, or Flo2/Flo3) NCCA or CCA RF signal in accordance with another aspect of the disclosure. With additional reference to FIG. 3A-1, the method 360 includes the control circuit 350 receiving a receive mode signal indicating a two-carrier (Flo1/Flo2, Flo1/Flo3, or Flo2/Flo3) NCCA or CCA received RF signal Srf with high power level (e.g., RSSI of each>TH) for both carrier signals (block 362). In this example, the power level of the two signal-modulated signals (e.g., as measured by the RSSIs of the corresponding baseband signals Sbb1/Sbb2, Sbb1/Sbb3, Sbb2/Sbb3) is sufficiently high (e.g.,>TH) that no amplification by any of the set of amplifier 315, 320, 325, or 330 is needed. Accordingly, in response to the receive mode, the control circuit 350 enables either first/second, first/third, or second/third split/bypass passive signal routing paths.
In this regard, the control circuit 350 turns ON one or the following sets of switching devices SW8/SW10/SW11, SW8/SW10/SW12, or SW8/SW11/SW12, and turns OFF switching devices SW1-7 and SW9 (block 364). Additionally, the control circuit 350 turns OFF all of the set of amplifiers 315, 320, 325, and 330 (block 366). Thus, in one case, the received RF signal Srf is routed to the first signal splitting node n1 via the impedance matching circuit 305 and switching device SW8, where the received RF signal is split into two RF signal portions and routed to the first and second downconverters 340-1 and 340-2 via the switching devices SW10/SW11, and AC-coupled capacitors C1/C2, respectively. In another case, the received RF signal Srf is routed from the RF signal input to the first signal splitting node n1 via the impedance matching circuit 305 and switching device SW8, wherein the received RF signal is split into two RF signal portions and routed to the first and third downconverters 340-1 and 340-3 via the switching devices SW10/SW12, and AC-coupled capacitors C1/C3, respectively. And, in yet another case, the received RF signal Srf is routed from the RF signal input to the first signal splitting node n1 via the impedance matching circuit 305 and switching device SW8, wherein the RF signal is split into two RF signal portions and routed to the second and third downconverters 340-2 and 340-3 via the switching devices SW11/SW12, and AC-coupled capacitors C2/C3, respectively.

In each of these cases, the received RF signal Srf is split at the first signal splitting node n1 at the inputs of the switching devices SW10/SW11, SW10/SW12, or SW11/SW12 for bypassing the amplifiers 315/320/325, 315/320/330, or 320/325/330, respectively. This is why the passive signal routing path has a split and bypass architecture. In the above cases, the downconverters 340-1/340-2, 340-1/340-3, or 340-2/340-3 are configured to frequency downconvert the signal-modulated carriers Flo1/Flo2, Flo1/Flo3, or Flo2/Flo3 to baseband signals Sbb1/Sbb2, Sbb1/Sbb3, or Sbb2/Sbb3, respectively.

It shall be understood that other signal routes from the RF signal input to the first signal splitting node n1 may be taken. For example, if the two signal-modulated carriers Flo1/Flo2, Flo1/Flo3, or Flo2/Flo3 have sufficiently high power level (e.g., RSSI of each of Sbb1/Sbb2, Sbb1/Sbb3, or Sbb2/Sbb3>TH) that it may saturate or significantly compress the corresponding pair of downconverters and produce distorted baseband signals, the control circuit 350 may alternatively turn ON switching devices SW1, SW2, and SW9, and turn OFF switching device SW8. In this configuration, the received RF signal Srf is routed from the RF signal input to the corresponding pair of downconverters via the impedance matching circuit 305, switching device SW1, gain control circuit 310, switching devices SW2 and SW9, the corresponding pair of switching devices SW10/SW11, SW10/SW12, or SW11/SW12, and corresponding pair of AC-coupled capacitors C1/C2, C1/C3, or C2/C3, respectively. Per this signal routing, the received RF signal Srf is routed through the gain control circuit 310 where, under the control of the control circuit 350, may be able to apply some attenuation to the received RF signal Srf to prevent saturation or significant compression of the corresponding pair of downconverters.

FIG. 3B-2 illustrates a flow diagram of an example method 370 of receiving and processing a three-carrier (Flo1-Flo3) NCCA or CCA RF signal in accordance with another aspect of the disclosure. With additional reference to FIG. 3B-1, the method 370 includes the control circuit 350 receiving a receive mode signal indicating a three-carrier (Flo1-Flo3) NCCA or CCA received RF signal with high power level (e.g., RSSI of each of Sbb1, Sbb2, and Sbb3>TH) for all three signal-modulated carriers (block 372). In this example, the power level of the three carrier signals is sufficiently high that no amplification by any of the set of amplifiers 315, 320, 325, or 330 is needed. Accordingly, in response to the receive mode, the control circuit 350 enables the split/bypass passive signal routing paths.

In this regard, the control circuit 350 turns ON the switching devices SW8 and SW10-12, and turns OFF switching devices SW1-7 and SW9 (block 374). Additionally, the control circuit 350 turns OFF all the amplifiers 315, 320, 325, and 330 (block 376). Thus, the received RF signal Srf is routed from the RF signal input to the downconverters 340-1 to 340-3 via the impedance matching circuit 305, switching devices SW8 and SW10 to SW12, and AC-coupled capacitors C1 to C3, respectively. In each of these cases, the received RF signal Srf is split into three RF signal portions at the signal splitting node n1 and routed to the set of downconverters 340-1 to 340-3 via the set of switching devices SW10 to SW12, respectively. Thus, the RF signal bypasses the set of amplifiers 315, 320, 325, and 330. Again, this is why the passive signal routing path has a split and bypass architecture. In this case, the downconverters 340-1, 340-2, and 340-3 are configured to frequency downconvert the signal-modulated carriers Flo1, Flo2, and Flo3 to baseband signals Sbb1, Sbb2, and Sbb3, respectively.

It shall be understood that other signal routes from the RF signal input to the first signal splitting node n1 may be taken. For example, if signal-modulated carriers Flo1-Flo3 have sufficiently high power level (e.g., RSSI of each of Sbb1-Sbb3>TH) that it may saturate or significantly compress the downconverters 340-1 to 340-3 to produce distorted baseband signals, the control circuit 350 may alternatively turn ON switching devices SW1, SW2, and SW9, and turn OFF switching device SW8. In this configuration, the received RF signal is routed from the RF signal input to the downconverters 340-1 to 340-3 via the impedance matching circuit 305, switching device SW1, gain control circuit 310, switching devices SW2 and SW9, switching devices SW10 to SW12, and AC-coupled capacitors C1 to C3, respectively. Per this signal routing, the received RF signal is routed through the gain control circuit 310 where, under the control of the control circuit 350, may be able to apply some attenuation to the received RF signal to prevent saturation or significant compression of any of the downconverters 340-1 to 340-3.

FIG. 3C-2 illustrates a flow diagram of an example method 380 of receiving a three-carrier (Flo1-Flo3) NCCA or CCA RF signal in accordance with another aspect of the disclosure. With additional reference to FIG. 3C-1, the method 380 includes the control circuit 350 receiving a receive mode signal indicating a three-carrier (Flo1-Flo3) NCCA or CCA received RF signal with signal-modulated carriers Flo2 and Flo3 having high power level (e.g., RSSI of each of Sbb2 and Sbb3>TH), and signal-modulated carrier Flo1 having nominal power level (e.g., RSSI of Sbb1<TH) (block 382). In this example, the power level of signal-modulated carriers Flo2 and Flo3 is sufficiently high that no amplification by the amplifiers 320, 325, and 330 is needed. Whereas the power level of signal-modulated carrier Flo1 is nominal such that amplification by amplifier 315 is needed. This may be the case where the signal-modulated carriers Flo2 and Flo3 were transmitted by the same base station (e.g., having common transmit signal power control), and signal-modulated carrier Flo1 was transmitted by a different base station (e.g., as in the case of a multi-sim application, or intra-or intercarrier application). Accordingly, in response to the receive mode, the control circuit 350 enables one of the active signal routing paths, and enables two out of three split-bypass passive signal routing paths.

In this regard, the control circuit 350 turns ON the switching devices SW3, SW4, SW9, SW11, and SW12, and turns OFF switching devices SW1, SW2, SW5, SW6, SW7, and SW8 (block 384). Additionally, the control circuit 350 turns ON amplifier 315, and turns OFF amplifiers 320, 325, and 330 (block 386). Thus, the received RF signal Srf is routed from the RF signal input to the second signal splitting node n2 via impedance matching circuit 305 and switching device SW3, and the received RF signal Srf is split into first and second RF signal portions at the second signal splitting node n2. The first RF signal portion being routed to the first signal splitting node n1 via the switching device SW9, where the first RF signal portions is split into a set of two RF signal portions, and routed to the downconverters 340-2 and 340-3 via switching device SW11/SW12 and AC-coupled capacitors C2/C3, respectively. The second RF signal portion is routed to the downconverter 340-1 via the amplifier 315, switching device SW4, and AC-coupled capacitor C1.

In the case of the split/bypass passive signal routing network, the received RF signal Srf is split at the first signal splitting node n1 at the inputs of the switching devices SW11 and SW12 for bypassing the amplifiers 320, 325, and 330. Again, this is why the passive signal routing path has a split and bypass architecture. In this case, the downconverters 340-1, 340-2, and 340-3 are configured to frequency downconvert the signal-modulated carriers Flo1, Flo2, and Flo3 into baseband signals Sbb1, Sbb2, and Sbb3, respectively.

It shall be understood that other signal routes between the RF signal input to the downconverters 340-1 to 340-3 may be taken. For example, if the signal-modulated carriers Flo2 and Flo3 is significantly high (e.g., RSSI of each Sbb2 and Sbb3>>TH) that it may saturate the downconverters 340-2 and 340-3, the control circuit 350 may alternatively turn ON switching devices SW1 and SW2, and turn OFF switching device SW3. In this configuration, the received RF signal is routed from the RF signal input to the downconverters 340-1 to 340-3 via the gain control circuit 310. Per this receiver configuration, the control circuit 350 may apply some attenuation to prevent saturation/compression of the downconverters 340-2 and 340-3 associated with the passive signal routing paths, while maintaining sufficient signal level (e.g., by increasing the gain of the amplifier 315) for the downconverter 340-1 associated with the active signal routing path.

In the above example, the active signal routing path corresponds to downconverter 340-1, and the passive signal routing paths correspond to downconverters 340-2 and 340-3. However, it shall be understood that the active signal routing path may correspond to downconverter 340-2 or 340-3, and the passive signal routing paths may correspond to downconverters 340-1/340-3 or 340-1/340-2, respectively.

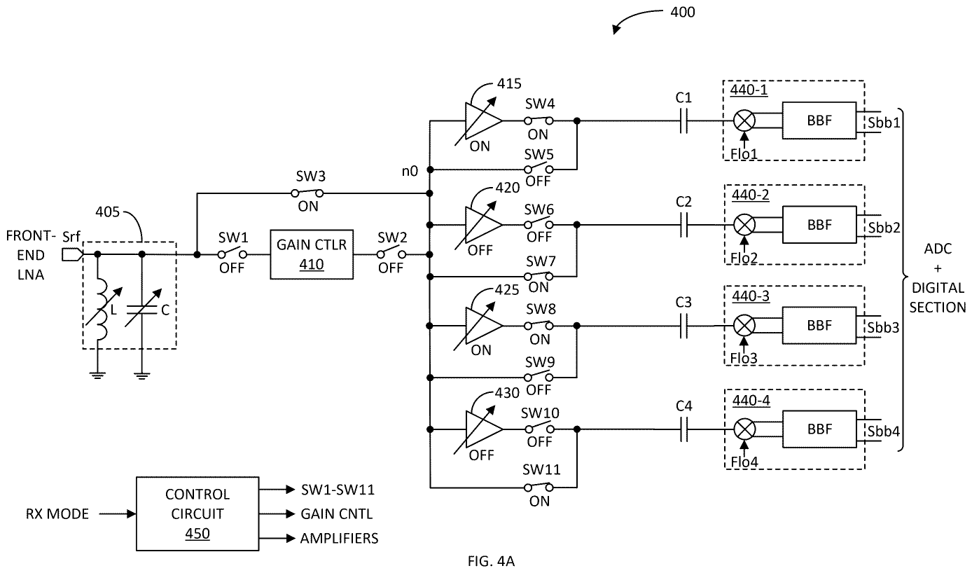

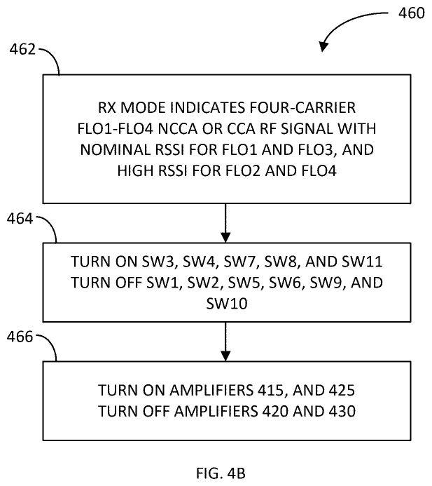

FIG. 4A illustrates a block diagram of an example radio frequency (RF) signal receiver 400 in a hybrid passive-active configuration in accordance with another aspect of the disclosure. Similar receiver 300, the receiver 400 may be situated between an RFFE LNA and an ADC plus digital section. The receiver 400 includes an impedance matching circuit 405 (e.g., parallel shunt inductor L and capacitor C, one or both of which may be programmable or variable), a set of switching devices SW1-SW11 (e.g., FETs, transmission gates, pass gates, etc.), a set of amplifiers (e.g., LNAs) 415, 420, 425, and 430, AC-coupled capacitors C1-C4, downconverters 440-1 to 440-4, and a control circuit 450.

The receiver 400 includes a set of signal routing paths extending from the RF signal input (e.g., coupled to an output of an RFFE LNA) to a signal splitting node n0. For example, a first signal routing path includes impedance matching circuit 405 and switching device SW3. Another signal routing path includes the impedance matching circuit 405, switching device SW1, gain control circuit 410, and switching device SW2.

The receiver 400 also includes a set of active signal routing paths extending from the signal splitting node n0 to the set of downconverters 440-1 to 440-4, respectively. For example, the set of active signal routing paths include: (1) amplifier 415, switching device SW4, and AC-coupled capacitor C1; (2) amplifier 420, switching device SW6, and AC-coupled capacitor C2; (3) amplifier 425, switching device SW8, and AC-coupled capacitor C3; and amplifier 430, switching device SW10, and AC-coupled capacitor C4, as summarized as follows:
(1) node n0→amplifier 415→SW4→C1→downconverter 440-1
(2) node n0→amplifier 420→SW6→C2→downconverter 440-2
(3) node n0→amplifier 425→SW8→C3→downconverter 440-3
(4) node n0→amplifier 430→SW10→C4→downconverter 440-4

The receiver 400 further includes a set of passive signal routing paths extending from the signal splitting node n0 to the set of downconverters 440-1 to 440-4, respectively. The set of passive signal routing paths includes switching devices SW5, SW7, SW9, and SW11 (e.g., FETs, transmission gates, pass gates, etc.), as summarized as follows
(1) node n0→SW5→C1→downconverter 440-1
(2) node n0→SW7→C2→downconverter 440-2
(3) node n0→SW9→C3→downconverter 440-3
(4) node n0→SW11→C4→downconverter 440-4

FIG. 4B illustrates a flow diagram of an example method 460 of receiving and processing a four-carrier (Flo1-Flo4) NCCA or CA RF signal Srf in accordance with another aspect of the disclosure. With additional reference to FIG. 4A, the method 460 includes the control circuit 450 receiving a receive mode signal indicating a four-carrier (Flo1-Flo4) NCCA or CA RF signal Srf with high power level for signal-modulated carriers Flo2 and Flo4 (e.g., RSSI of each of Sbb2 and Sbb4>TH), and nominal power level for signal-modulated carriers Flo1 and Flo3 (e.g., RSSI of Sbb1 and Sbb3<TH) (block 462). In this example, the power level of signal-modulated carriers Flo2 and Flo4 is sufficiently high that no amplification by amplifiers 420 and 430 is needed, respectively. Whereas the power level of signal-modulated carriers Flo1 and Flo3 is nominal such that amplification by amplifiers 415 and 425 may be needed, respectively. This may be the case where the signal-modulated carriers Flo2 and Flo4 were transmitted by the same base station (e.g., providing a common transit power control), and signal-modulated carriers Flo1 and Flo3 were transmitted by different one or more base stations (e.g., as in the case of a multi-sim application, or intra-or intercarrier application). Accordingly, in response to the receive mode, the control circuit 450 enables the first and third active signal routing paths, and the second and fourth split/bypass passive signal routing paths.

In this regard, the control circuit 450 turns ON the switching devices SW3, SW4, SW7, SW8, and SW11, and turns OFF switching devices SW1, SW2, SW5, SW6, SW9, and SW10 (block 464). Additionally, the control circuit 450 turns ON amplifiers 415 and 425, and turns OFF amplifiers 420 and 430 (block 466). Thus, via the split/bypass passive signal routing paths, the received RF signal Srf is routed from the RF signal input to the downconverters 440-2 to 440-4 via the impedance matching circuit 405, switching device SW3, switching devices SW7/SW11, and AC-coupled capacitors C2/C4, respectively. Via the active signal routing paths, the received RF signal is routed from the RF signal input to the downconverters 440-1 and 440-3 via the impedance matching circuit 405, switching device SW3, amplifiers 415/425, switching devices SW 4/SW8, and AC-coupled capacitors C1/C3, respectively.

In the case of the split/bypass passive signal routing network, the received RF signal Srf is split at the splitting node n0 at the inputs of the switching devices SW7 and SW11 for bypassing the amplifiers 420 and 430, respectively. Again, this is why the passive signal routing network has a split and bypass architecture. In this case, the downconverters 440-2 and 440-4 are configured to frequency downconvert the signal-modulated carriers Flo2 and Flo4 to baseband signals Sbb2 and Sbb4, respectively. Similarly, with regard to the active signal routing paths, the downconverters 440-1 and 440-3 are configured to frequency downconvert the signal-modulated carriers Flo1 and Flo3 to baseband signals Sbb1 and Sbb3, respectively.

It shall be understood that other signal routes may be taken via between the RF signal input and the signal splitting node n0. For example, if the signal-modulated carriers Flo2 and Flo3 have a sufficiently high power level (e.g., RSSI>TH) that it may saturate or significantly compress the downconverters 440-2 and 440-4 such that distorted baseband signals are produced, the control circuit 450 may alternatively turn ON switching devices SW1, and SW2, and turn OFF switching device SW3. In this configuration, the received RF signal is routed from the RF signal input to the signal splitting node n0 via the gain control circuit 310. Per this configuration, the control circuit 350 may apply some attenuation to prevent saturation or significant compression of the downconverters 440-2 and 440-4 associated with the passive signal routing paths, while maintaining sufficient signal level (e.g., by increasing the gains of amplifiers 415 and 425) for the downconverters 440-1 and 440-3 associated with the active signal routing paths.

Although, in the above example, the active signal routing paths correspond to downconverters 440-1 and 440-3 and the passive signal routing paths correspond to downconverters 440-2 and 440-4, it shall be understood that the active signal routing paths may correspond to any one or two of the downconverters 440-1 to 440-4, and the passive signal routing paths may correspond to any other two or two of the downconverters 440-1 to 440-4.

FIG. 5 illustrates a block diagram of an example wireless communication system 500 in accordance with another aspect of the disclosure. The wireless communication system 500 includes a user equipment (UE) 510, a first wireless wide area network (WWAN) base station (BS) 520, and a second WWAN BS 530. The UE 510 may include a transceiver for wirelessly communicating with the first WWAN BS 520 and the second WWAN BS 530 per any one or more WWAN communication protocols, such as 5G or 6G NR or other protocol.

The transceiver employed by the UE 510 may include any of the RF signal receivers 300, 400, 680, and 700 discussed herein for receiving and processing RF signals including a set of signal-modulated carriers in accordance with NCCA or CCA. As previously discussed, under the category of NCCA, there may be multiple sim intra-CA and inter-carrier aggregation scenarios, where the non-contiguous frequency band signals may have been transmitted by different base stations, such as WWAN BS 520 and WWAN BS 530. This may result in a received RF signal including signal-modulated carriers per NCCA with different power levels at the UE 510, which may require a hybrid passive-active receiver configuration previously discussed.

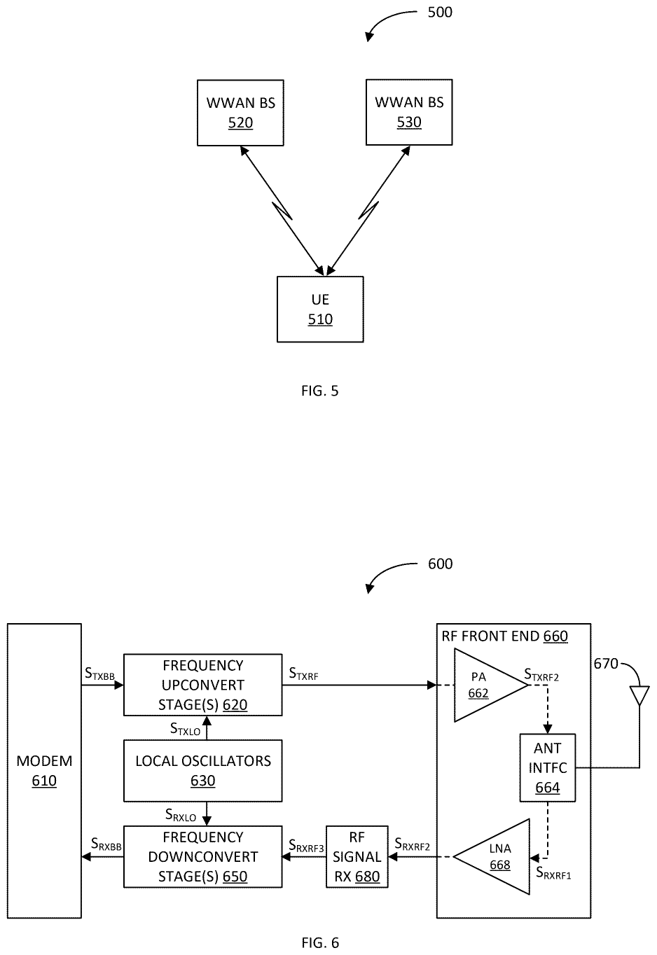

FIG. 6 illustrates a block diagram of an example transceiver 600 in accordance with another aspect of the disclosure. The transceiver 600 may be employed in the UE 510 to wirelessly communicate with the WWAN BS 520.

The transceiver 600 includes a modem 610 (e.g., ADC plus digital section), one or more frequency upconverting stage(s) 620, local oscillators 630, one or more frequency downconverting stage(s) 650, a radio frequency (RF) front end 660, an antenna 670 (e.g., an antenna array), and an RF signal receiver 680, which may be implemented per any of the RF signal receivers 300, 400, and 700 described herein. The RF front end 660, in turn, includes a power amplifier (PA) 662, an antenna interface 664 (e.g., duplexer, diplexer, or other type of antenna interface), and a low noise amplifier (LNA) 668.

With regard to signal transmission, the modem 610 is configured to generate a transmit baseband signal S_{TXBB}. The one or more frequency upconverting stage(s) 620 is configured to frequency upconvert the transmit baseband signal S_{TXBB} (e.g., from baseband (BB) to radio frequency (RF) directly or via one or more intermediate frequencies (IFs)) using one or more transmit local oscillator signal(s) S_{TXLO} generated by the local oscillators 630 to generate a transmit RF signal S_{TXRF1}. The PA 662 is configured to amplify the transmit RF signal S_{TXRF1} to generate an output RF signal S_{TXRF2}. The output RF signal S_{TXRF2} is provided to the antenna 670 via the antenna interface 664. The antenna 670 is configured to wirelessly radiate the output RF signal S_{TXRF2}.

With regard to signal reception, the antenna 670 may wirelessly sense/pickup a received RF signal S_{RXRF1}, which is provided to the LNA 668 via the antenna interface 664. The LNA 668 is configured to amplify the received RF signal S_{RXRF1} to generate an amplified received RF signal S_{RXRF2}. The RF signal receiver 680 may receive and process the received RF signal S_{RXRF2}, which may include a set of different signal-modulated carriers in accordance with NCCA or CCA, using the split/bypass passive signal routing and hybrid passive-active signal routing architecture described with respect to RF signal receivers 300, 400, 680, and 700, to generate RF signal S_{RXRF3}. The one or more frequency downconverting stage(s) 650 is configured to frequency downconvert the received RF signal S_{RXRF3} (e.g., from RF to BB directly or via one or more IFs) using a set of received local oscillator signals S_{RXLO} generated by the local oscillators 630 to generate a set of baseband (BB) signals S_{RXBB}. The modem 610 may receive and process the set of BB signal S_{RXBB} to extract and/or recover information or data therein. The modem 610 may also determine the RSSIs of the set of baseband (BB) signals S_{RXBB} to set the receive mode of the RF signal receiver 680 as previously discussed.

The components of the transceiver 600 may be implemented as separate components or integrated into one or more integrated circuits (ICs) in various different manners. For example, the modem 610 may be integrated with the frequency converting components 620, 630, and 650 into a single IC. Similarly, the frequency converting components 620, 630, and 650 may be integrated with the RF front end 660 including the RF signal receiver 680 into a single IC. Or, the modem 610, the frequency converting components 620, 630, and 650, and the RF front end 660 including the RF signal receiver 680 may be integrated into a single IC.

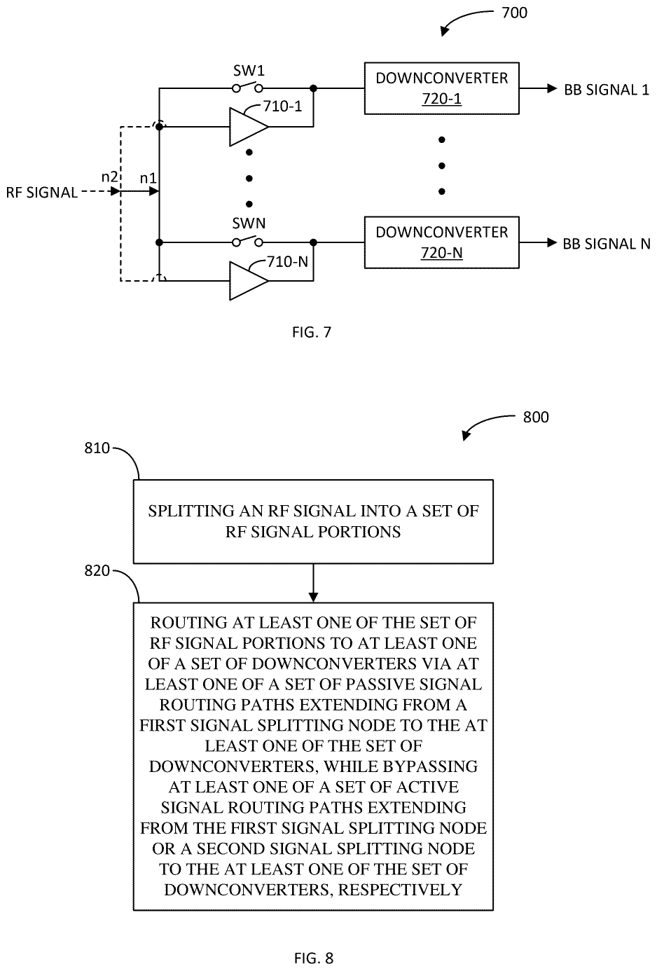

FIG. 7 illustrates a block diagram of an example RF signal receiver 700 in accordance with another aspect of the disclosure. The RF signal receiver 700 includes a set of downconverters 710-1 to 710-N, where N is an integer. The RF signal receiver 700 includes a set of passive signal routing paths extending from a first signal splitting node n1 (configured to split an RF signal in one configuration) to the set of downconverters 720-1 to 720-N via a first set of switching devices SW1 to SWN, respectively. The RF signal receiver 700 further includes a set of active signal routing paths extending from the first signal splitting node n1 or a second signal splitting node n2 (configured to split an RF signal in another configuration) to the set of downconverters 720-1 to 720-N via a set of amplifiers 710-1 to 710-N, respectively. The set of downconverters 720-1 to 720-N are configured to frequency downconvert the RF signal to generate a set of baseband signals BB signal 1 to BB signal N, respectively.

FIG. 8 illustrates a flow diagram of an example method 800 of receiving and processing an RF signal in accordance with another aspect of the disclosure. The method 800 includes splitting an RF signal into a set of RF signal portions at a first splitting node (block 810). Example of means for splitting an RF signal into a set of RF signal portions at a first splitting node include any of the first signal splitting nodes n0, n1 or n2 described herein.

The method 800 further includes routing at least one of the set of RF signal portions to at least one of the set of downconverters via at least one of a set of passive signal routing paths extending from a first signal splitting node to the set of downconverters, while bypassing at least one of a set of active signal routing paths extending from the first signal splitting node or a second signal splitting node to the set of downconverters, respectively (block 820). Examples of means for routing at least one of the set of RF signal portions to at least one of a set of downconverters via at least one of a set of passive signal routing paths extending from the first signal splitting node to the at least one of the set of downconverters, while bypassing a set of active signal routing paths extending from the first signal splitting node n1 or a second signal splitting node n2 to the at least one of the set of downconverters, respectively.

The following provides an overview of aspects of the present disclosure:

Aspect 1: A radio frequency (RF) signal receiver, comprising: a set of downconverters; a set of passive signal routing paths extending from a first signal splitting node to the set of downconverters via a first set of switching devices, respectively; and a set of active signal routing paths extending from the first signal splitting node or a second signal splitting node to the set of downconverters via a set of amplifiers, respectively.

Aspect 2: The RF signal receiver of aspect 1, further comprising a control circuit configured to turn on the first set of switching devices in accordance with a first receive mode, wherein: the first signal splitting node is configured to split a first RF signal into a first set of RF signal portions, and the set of passive signal routing paths are configured to route the first set of RF signal portions to the set of downconverters via the first set of switching devices while bypassing the set of active signal routing paths, respectively.

Aspect 3: The RF signal receiver of aspect 2, wherein the control circuit, in accordance with the first receive mode, is configured to turn off the set of amplifiers.

Aspect 4: The RF signal receiver of aspect 2 or 3, wherein: the set of active signal routing paths comprise a second set of switching devices coupled in series with the set of amplifiers between the first or second signal splitting node and the set of downconverters, respectively, and the control circuit, in accordance with the first receive mode, is configured to turn off the second set of switching devices.

Aspect 5: The RF signal receiver of any one of aspects 2-4, wherein: the first RF signal includes a set of signal-modulated carriers situated within a set of frequency bands, and the set of downconverters are configured to frequency downconvert the set of signal-modulated carriers into a set of baseband signals, respectively.

Aspect 6: The RF signal receiver of aspect 5, wherein at least two of the set of frequency bands are disjoined in frequency in accordance with non-contiguous carrier aggregation (NCCA).

Aspect 7: The RF signal receiver of aspect 5 or 6, wherein at least two of the set of frequency bands are contiguous in frequency in accordance with contiguous carrier aggregation (CCA).

Aspect 8: The RF signal receiver of any one of aspects 5-7, wherein the control circuit is configured to turn on the first set of switching devices in accordance with the first receive mode based on the set of baseband signals each having a power level above a threshold.

Aspect 9: The RF signal receiver of any one of aspects 2-8, wherein the control circuit, in accordance with a second receive mode, is configured to: turn on at least one of the first set of switching devices and turn off at least another one of the first set of switching devices; and turn on at least one of the set of amplifiers; wherein: the first or second signal splitting node is configured to split a second RF signal into a second set of RF signal portions, at least one of the set of passive signal routing paths is configured to route at least one of the second set of RF signal portions to at least one of the set of downconverters via the at least one of the first set of switching devices, and at least one of the set of active signal routing paths is configured to route at least another one of the second set of RF signal portions to at least another one of the set of downconverters via the at least one of the set of amplifiers, respectively.

Aspect 10: The RF signal receiver of aspect 9, wherein: the set of active signal routing paths include a second set of switching devices coupled in series with the set of amplifiers between the first or second splitting node and the set of downconverters, and the at least one of the set of active signal routing paths is configured to route the at least another one of the second set of RF signal portions to the at least another one of the set of downconverters via at least one of the second set of switching devices, respectively.

Aspect 11: The RF signal receiver of aspect 9 or 10, wherein: the second RF signal includes a set of signal-modulated carriers situated within a set of frequency bands, respectively, and at least two of the set of frequency bands are disjoined in frequency in accordance with non-contiguous carrier aggregation (NCCA).

Aspect 12: The RF signal receiver of any one of aspects 9-11, wherein: the second RF signal includes a set of signal-modulated carriers situated within a set of frequency bands, respectively, and at least two of the set of frequency bands are contiguous in frequency in accordance with contiguous carrier aggregation (CCA).

Aspect 13: The RF signal receiver of any one of aspects 9-12, wherein: the second RF signal includes a set of signal-modulated carriers situated within a set of frequency bands, respectively; the at least one of the set of downconverters is configured to frequency downconvert at least one of the set of signal-modulated carriers into at least one of a set of baseband signals, respectively; and the at least another one of the set of downconverters is configured to frequency downconvert at least another one of the set of signal-modulated carriers into at least another one of the set of baseband signals, respectively.

Aspect 14: The RF signal receiver of aspect 13, wherein the control circuit is configured to turn on the at least one of the first set of switching devices, turn off the at least another one of the first set of switching devices, and turn on the at least one of the set of amplifiers in accordance with the second receive mode based on: the at least one of the set of the set of baseband signals each having a power level above a threshold; and the at least another one of the set of the set of baseband signals each having a power level below the threshold.

Aspect 15: The RF signal receiver of any one of aspects 1-14, wherein the set of amplifiers are coupled between the second signal splitting node and the set of downconverters, respectively.

Aspect 16: The RF signal receiver of aspect 15, further comprising a second set of switching devices coupled in series with the set of amplifiers between the second signal splitting node and the set of downconverters, respectively.

Aspect 17: The RF signal receiver of aspect 16, further comprising: a first signal routing path including a first switching device extending from an RF signal input to the first signal splitting node; and a second signal routing path including a second switching device extending from the RF signal input to the second signal splitting node.

Aspect 18: The RF signal receiver of aspect 17, further comprising a control circuit configured, in accordance with a receive mode, to turn on the first switching device, turn on at least two of the first set of switching devices, turn off the second switching device, turn off the second set of switching devices, and turn off the set of amplifiers, and wherein: the first signal routing path is configured to route an RF signal to the first signal splitting node via the first switching device, the first signal splitting node is configured to split the RF signal into at least two RF signal portions, and at least two of the set of passive signal routing paths are configured to route the at least two RF signal portions to at least two of the set of downconverters via the at least two of the first set of switching devices, respectively.

Aspect 19: The RF signal receiver of aspect 18, wherein: the RF signal includes a set of signal-modulated carriers situated within a set of frequency bands, respectively; and the at least two of the set of downconverters is configured to frequency downconvert at least two of the set of signal-modulated carriers to at least two of a set of baseband signals, respectively.

Aspect 20: The RF signal receiver of aspect 19, wherein the control circuit is configured to turn on the first switching device, turn on the at least two of the first set of switching devices, turn off the second switching device, turn off the second set of switching devices, and turn off the set of amplifiers in accordance with the receive mode based on the at least two of the set of the set of baseband signals each having a power level above a threshold.

Aspect 21: The RF signal receiver of any one of aspects 17-20, further comprising a third signal routing path including a third switching device coupled between the second signal splitting node and the first signal splitting node.

Aspect 22: The RF signal receiver of aspect 21, further comprising a control circuit configured, in accordance with a receive mode, to turn off the first switching device, turn on at least two of the first set of switching devices, turn off at least one of the first set of switching devices, turn on the second and third switching devices, turn on at least one of the set of amplifiers, and turn on at least one of the second set of switching devices coupled in series with the at least one of the set of amplifiers, respectively; wherein: the second signal routing path is configured to route an RF signal from the RF signal input to the second signal splitting node via the second switching device, the second signal splitting node is configured to split the RF signal into first and second RF signal portions, the third signal routing path is configured to route the first RF signal portion to the first signal splitting node via the third switching device, the first signal splitting node is configured to split the first RF signal portion into a set of at least two RF signal portions, at least two of the set of passive signal routing paths are configured to route the set of at least two RF signal portions to at least two of the set of downconverters via the at least two of the first set of switching devices, respectively; and wherein the second RF signal portion is routed to at least another one of the set of downconverters via the at least one of the set of amplifiers and the at least one of the second set of switching devices, respectively.

Aspect 23: The RF signal receiver of aspect 22, wherein: the RF signal includes a set of signal-modulated carriers situated within a set of frequency bands, respectively; the at least two of the set of downconverters are configured to frequency downconvert at least two of the set of signal-modulated carriers into at least two of a set of baseband signals, respectively; and the at least another one of the set of downconverters is configured to frequency downconvert at least another one of the set of signal-modulated carriers into at least another one of the set of baseband signals, respectively.

Aspect 24: The RF signal receiver of aspect 23, wherein the control circuit is configured to turn off the first switching device, turn on the at least two of the first set of switching devices, turn off at least one of the first set of switching devices, turn on the second and third switching devices, turn on the at least one of amplifiers, and turn on the at least one of the second set of switching devices in accordance with the receive mode based on: the at least two of the set of the set of baseband signals each having a power level above a threshold; and the at least another one of the set of baseband signals each having a power level below the threshold.

Aspect 25: The RF signal receiver of any one of aspects 21-24, further comprising a fourth signal routing path including at least one switching device and a gain control circuit coupled in series between the RF signal input and the second signal splitting node.

Aspect 26: The RF signal receiver of any one of aspects 1-15, wherein the set of active signal routing paths extend from the first signal splitting node to the set of downconverters via the set of amplifiers, respectively.

Aspect 27: The RF signal receiver of any one of aspects 1-26, further comprising a control circuit configured to operate the set of passive signal routing paths and/or the set of active routing paths to route a radio frequency (RF) signal to the set of downconverters, wherein the RF signal includes a set of carriers in accordance with a carrier aggregation receive mode.

Aspect 28: A method of receiving and processing radio frequency (RF) signals, comprising: splitting an RF signal into a set of RF signal portions; and routing at least one of the set of RF signal portions to at least one of a set of downconverters via at least one of a set of passive signal routing paths extending from a first signal splitting node to the at least one of the set of downconverters, while bypassing at least one of a set of active signal routing paths extending from the first signal splitting node or a second signal splitting node to the at least one of the set of downconverters, respectively.

Aspect 29: The method of claim 28, further comprising routing at least another one of the set of RF signal portions to at least another one of the set of downconverters via at least another one of the set of active signal routing paths, respectively.

Aspect 30: The method of aspect 29, wherein the first RF signal includes a set of signal-modulated carriers situated within a set of frequency bands, and further comprising operating the set of downconverters to frequency downconvert the set of signal-modulated carriers into a set of baseband signals, respectively.

Aspect 31: The method of aspect 30, wherein at least two of the set of frequency bands are disjoined in frequency in accordance with non-contiguous carrier aggregation (NCCA).

Aspect 32: The method of aspect 30 or 31, wherein at least two of the set of frequency bands are contiguous in frequency in accordance with contiguous carrier aggregation (CCA).

Aspect 33: The method of any one of aspects 30-32, wherein splitting the first RF signal and routing the first set of RF signal portions in accordance with the first receive mode are based on the set of baseband signals each having a power level above a threshold.

Aspect 34: The method of any one of aspects 29-33, further comprising: splitting a second RF signal into first and second RF signal portions at the second signal splitting node in accordance with a second receive mode; splitting the first RF signal portion into at least two RF signal portions as the first signal splitting node in accordance with the second receive mode; routing the at least two RF signal portions to at least two of the set of downconverters via at least two of the set of passive signal routing paths, while bypassing at least two of the set of active signal routing paths extending from the second signal splitting node to the at least two of the set of downconverters, respectively, in accordance with the second receive mode; and routing the second RF signal portion to at least another one of the set of downconverters via at least another one of the set of active signal routing paths, respectively, in accordance with the second receive mode.

Aspect 35: The method of aspect 34, wherein the second RF signal includes a set of signal-modulated carriers situated within a set of frequency bands, respectively, and further comprising operating the at least two of the set of downconverters to frequency downconvert at least two of the set of signal-modulated carriers into at least two of a set of baseband signals, and operating the at least another one of the set of downconverters to frequency downconvert at least another one of the set of signal-modulated carriers into at least another one of the set of baseband signals, respectively.

Aspect 36: The method of aspect 35, wherein the RF signal includes the set of signal-modulated carriers in accordance with a carrier aggregation receive mode.

Aspect 37: The method of aspect 35 or 36, wherein at least two of the set of frequency bands are disjoined in frequency in accordance with non-contiguous carrier aggregation (NCCA).

Aspect 38: The method of any one of aspects 35 to 37, wherein at least two of the set of frequency bands are contiguous in frequency in accordance with contiguous carrier aggregation (CCA).

Aspect 39: The method of any one of aspects 35-38, wherein splitting the second RF signal, splitting the first RF signal portion, routing the least two RF signal portions, and routing the second RF signal portion in accordance with the second receive mode are based on: the at least two of the set of baseband signals each having a power level above a threshold; and the at least another one of the set of baseband signals each having a power level below the threshold.

Aspect 40: The method of any one of aspects aspect 28-39, further comprising routing at least another one of the set of RF signal portions to at least another one of the set of downconverters via at least another one of the set of active signal routing paths, respectively.

Aspect 41: An apparatus, comprising: means for splitting a RF signal into a set of RF signal portions; and means for routing at least one of the set of RF signal portions to at least one of a set of downconverters via at least one of a set of passive signal routing paths extending from a first signal splitting node to the set of downconverters, while bypassing at least one of a set of active signal routing paths extending from the first signal splitting node or a second signal splitting node to the set of downconverters, respectively.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. A radio frequency (RF) signal receiver, comprising:
a set of downconverters;
a set of passive signal routing paths extending from a first signal splitting node to the set of downconverters via a first set of switching devices, respectively; and
a set of active signal routing paths extending from the first signal splitting node or a second signal splitting node to the set of downconverters via a set of amplifiers, respectively.

2. The RF signal receiver of claim 1, further comprising a control circuit configured to turn on the first set of switching devices in accordance with a first receive mode, wherein: the first signal splitting node is configured to split a first RF signal into a first set of RF signal portions, and the set of passive signal routing paths are configured to route the first set of RF signal portions to the set of downconverters via the first set of switching devices while bypassing the set of active signal routing paths, respectively.

3. The RF signal receiver of claim 2, wherein the control circuit, in accordance with the first receive mode, is configured to turn off the set of amplifiers.

4. The RF signal receiver of claim 2, wherein: the set of active signal routing paths comprise a second set of switching devices coupled in series with the set of amplifiers between the first or second signal splitting node and the set of downconverters, respectively, and the control circuit, in accordance with the first receive mode, is configured to turn off the second set of switching devices.

5. The RF signal receiver of claim 2, wherein: the first RF signal includes a set of signal-modulated carriers situated within a set of frequency bands, and the set of downconverters are configured to frequency downconvert the set of signal-modulated carriers into a set of baseband signals, respectively.

6. The RF signal receiver of claim 5, wherein at least two of the set of frequency bands are disjoined in frequency in accordance with non-contiguous carrier aggregation (NCCA).

7. The RF signal receiver of claim 5, wherein at least two of the set of frequency bands are contiguous in frequency in accordance with contiguous carrier aggregation (CCA).

8. The RF signal receiver of claim 5, wherein the control circuit is configured to turn on the first set of switching devices in accordance with the first receive mode based on the set of baseband signals each having a power level above a threshold.

9. The RF signal receiver of claim 2, wherein the control circuit, in accordance with a second receive mode, is configured to:
turn on at least one of the first set of switching devices and turn off at least another one of the first set of switching devices; and
turn on at least one of the set of amplifiers;
wherein: the first or second signal splitting node is configured to split a second RF signal into a second set of RF signal portions, at least one of the set of passive signal routing paths is configured to route at least one of the second set of RF signal portions to at least one of the set of downconverters via the at least one of the first set of switching devices, and at least one of the set of active signal routing paths is configured to route at least another one of the second set of RF signal portions to at least another one of the set of downconverters via the at least one of the set of amplifiers, respectively.

10. The RF signal receiver of claim 9, wherein: the set of active signal routing paths include a second set of switching devices coupled in series with the set of amplifiers between the first or second splitting node and the set of downconverters, and the at least one of the set of active signal routing paths is configured to route the at least another one of the second set of RF signal portions to the at least another one of the set of downconverters via at least one of the second set of switching devices, respectively.

11. The RF signal receiver of claim 9, wherein: the second RF signal includes a set of signal-modulated carriers situated within a set of frequency bands, respectively, and at least two of the set of frequency bands are disjoined in frequency in accordance with non-contiguous carrier aggregation (NCCA).

12. The RF signal receiver of claim 9, wherein: the second RF signal includes a set of signal-modulated carriers situated within a set of frequency bands, respectively, and at least two of the set of frequency bands are contiguous in frequency in accordance with contiguous carrier aggregation (CCA).

13. The RF signal receiver of claim 9, wherein:
the second RF signal includes a set of signal-modulated carriers situated within a set of frequency bands, respectively;
the at least one of the set of downconverters is configured to frequency downconvert at least one of the set of signal-modulated carriers into at least one of a set of baseband signals, respectively; and
the at least another one of the set of downconverters is configured to frequency downconvert at least another one of the set of signal-modulated carriers into at least another one of the set of baseband signals, respectively.

14. The RF signal receiver of claim 13, wherein the control circuit is configured to turn on the at least one of the first set of switching devices, turn off the at least another one of the first set of switching devices, and turn on the at least one of the set of amplifiers in accordance with the second receive mode based on:
the at least one of the set of the set of baseband signals each having a power level above a threshold; and
the at least another one of the set of the set of baseband signals each having a power level below the threshold.

15. The RF signal receiver of claim 1, wherein the set of amplifiers are coupled between the second signal splitting node and the set of downconverters, respectively.

16. The RF signal receiver of claim 15, further comprising a second set of switching devices coupled in series with the set of amplifiers between the second signal splitting node and the set of downconverters, respectively.

17. The RF signal receiver of claim 16, further comprising:
a first signal routing path including a first switching device extending from an RF signal input to the first signal splitting node; and
a second signal routing path including a second switching device extending from the RF signal input to the second signal splitting node.

18. The RF signal receiver of claim 17, further comprising a control circuit configured, in accordance with a receive mode, to turn on the first switching device, turn on at least two of the first set of switching devices, turn off the second switching device, turn off the second set of switching devices, and turn off the set of amplifiers, and wherein: the first signal routing path is configured to route an RF signal to the first signal splitting node via the first switching device, the first signal splitting node is configured to split the RF signal into at least two RF signal portions, and at least two of the set of passive signal routing paths are configured to route the at least two RF signal portions to at least two of the set of downconverters via the at least two of the first set of switching devices while bypassing at least two of the set of active signal routing paths, respectively.

19. The RF signal receiver of claim 18, wherein:
the RF signal includes a set of signal-modulated carriers situated within a set of frequency bands, respectively; and
the at least two of the set of downconverters is configured to frequency downconvert at least two of the set of signal-modulated carriers to at least two of a set of baseband signals, respectively.

20. The RF signal receiver of claim 19, wherein the control circuit is configured to turn on the first switching device, turn on the at least two of the first set of switching devices, turn off the second switching device, turn off the second set of switching devices, and turn off the set of amplifiers in accordance with the receive mode based on the at least two of the set of the set of baseband signals each having a power level above a threshold.

21. The RF signal receiver of claim 17, further comprising a third signal routing path including a third switching device coupled between the second signal splitting node and the first signal splitting node.

22. The RF signal receiver of claim 21, further comprising a control circuit configured, in accordance with a receive mode, to turn off the first switching device, turn on at least two of the first set of switching devices, turn off at least one of the first set of switching devices, turn on the second and third switching devices, turn on at least one of the set of amplifiers, and turn on at least one of the second set of switching devices coupled in series with the at least one of the set of amplifiers, respectively; wherein: the second signal routing path is configured to route an RF signal from the RF signal input to the second signal splitting node via the second switching device, the second signal splitting node is configured to split the RF signal into first and second RF signal portions, the third signal routing path is configured to route the first RF signal portion to the first signal splitting node via the third switching device, the first signal splitting node is configured to split the first RF signal portion into a set of at least two RF signal portions, at least two of the set of passive signal routing paths are configured to route the set of at least two RF signal portions to at least two of the set of downconverters via the at least two of the first set of switching devices, respectively; and wherein the second RF signal portion is routed to at least another one of the set of downconverters via the at least one of the set of amplifiers and the at least one of the second set of switching devices, respectively.

23. The RF signal receiver of claim 22, further comprising a fourth signal routing path including at least one switching device and a gain control circuit coupled in series between the RF signal input and the second signal splitting node.

24. The RF signal receiver of claim 1, wherein the set of active signal routing paths extend from the first signal splitting node to the set of downconverters via the set of amplifiers, respectively.

25. The RF signal receiver of claim 1, further comprising a control circuit configured to operate the set of passive signal routing paths and/or the set of active routing paths to route a radio frequency (RF) signal to the set of downconverters, wherein the RF signal includes a set of carriers in accordance with a carrier aggregation receive mode.

26. A method of receiving and processing radio frequency (RF) signals, comprising:
splitting an RF signal into a set of RF signal portions; and
routing at least one of the set of RF signal portions to at least one of a set of downconverters via at least one of a set of passive signal routing paths extending from a first signal splitting node to the at least one of the set of downconverters, while bypassing at least one of a set of active signal routing paths extending from the first signal splitting node or a second signal splitting node to the at least one of the set of downconverters, respectively.

27. The method of claim 26, further comprising routing at least another one of the set of RF signal portions to at least another one of the set of downconverters via at least another one of the set of active signal routing paths, respectively.

28. The method of claim 26, wherein the RF signal includes a set of signal-modulated carriers situated within a set of frequency bands, and further comprising operating the set of downconverters to frequency downconvert the set of signal-modulated carriers into a set of baseband signals, respectively.

29. The method of claim 28, wherein the RF signal includes the set of signal-modulated carriers in accordance with a carrier aggregation receive mode.

30. An apparatus, comprising:
means for splitting an RF signal into a set of RF signal portions; and
means for routing at least one of the set of RF signal portions to at least one of a set of downconverters via at least one of a set of passive signal routing paths extending from a first signal splitting node to the at least one of the set of downconverters, while bypassing at least one of a set of active signal routing paths extending from the first signal splitting node or a second signal splitting node to the at least one of the set of downconverters, respectively.
